(19) United States
(12) Patent Application Publication
(10) Pub. No.: US 2009/0262065 A1
(43) Pub. Date: Oct. 22, 2009

(54) LIQUID CRYSTAL DISPLAY AND METHOD OF DRIVING THE SAME

(75) Inventors: Ho-Sik SHIN, Ahnyang-si (KR); Se-Ki PARK, Suwon-si (KR); Eun-Jeong KANG, Cheonan-si (KR); Jeom-Oh KIM, Jeollabuk-do (KR); Hee-Kwang SONG, Ahnyang-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/388,239

(22) Filed: Feb. 18, 2009

(30) Foreign Application Priority Data
Apr. 18, 2008 (KR) 10-2008-0036328

(51) Int. Cl. G09G 3/36; G02F 1/13357

(52) U.S. Cl. 345/102; 349/61

(57) ABSTRACT

A liquid crystal display includes a liquid crystal panel having display blocks arranged in a first matrix thereon, and light-emitting blocks which provide light to the liquid crystal panel. Each of the light-emitting blocks corresponds to a corresponding column of the first matrix and provides the light to a corresponding column of display blocks in the corresponding column of the first matrix. A frame during which an image is displayed on the liquid crystal display is divided into time slots, and a number of the time slots is equal to a number of the corresponding display blocks included in each column of the first matrix. A luminance of the light provided by each of the light-emitting blocks during each time slot of the frame is controlled based on an image data signal supplied to the corresponding column of the first matrix.

This application claims priority to Korean Patent Application No. 10-2008-0036328, filed on Apr. 18, 2008, and all the benefits accruing therefrom under 35 U.S.C. §119, the contents of which in its entirety are herein incorporated by reference.

### BACKGROUND OF THE INVENTION

1. Field of the Invention

The present invention relates to a liquid crystal display (“LCD”) and a method of driving the same, and more particularly, to an LCD having enhanced display quality and a method of driving the same.

2. Description of the Related Art

A liquid crystal display (“LCD”) typically includes a first display substrate having a plurality of pixel electrodes, a second display substrate having a plurality of common electrodes, and a liquid crystal panel disposed therebetween. The liquid crystal panel generally includes a dielectrically anisotropic liquid crystal layer injected between the first display substrate and the second display substrate. The LCD displays a desired image by adjusting an electric field formed between the pixel electrodes and the common electrodes. More specifically, the LCD adjusts an intensity of the electric field, and thus controls an amount of light which transmits through the liquid crystal panel to display the desired image. The LCD is not a self light-emitting display, and therefore includes a plurality of light-emitting blocks, for example.

Recently, a technology which controls a luminance of each light-emitting block of the plurality of light-emitting blocks has been developed. Specifically, the luminance is controlled according to an image displayed on the liquid crystal panel in order to enhance image quality. However, a need still exists for improved display quality in an LCD which controls luminances of light-emitting blocks to display an image.

### BRIEF SUMMARY OF THE INVENTION

Exemplary embodiments of the present invention provide a liquid crystal panel (“LCD”) with enhanced display quality.

Exemplary embodiments of the present invention also provide a method of driving an LCD with enhanced display quality.

According to an exemplary embodiment of the present invention, an LCD includes a liquid crystal panel which includes display blocks arranged in a first matrix thereon, and light-emitting blocks which provide light to the liquid crystal panel. Each of the light-emitting blocks corresponds to a corresponding column of the first matrix and provides the light to a corresponding column of display blocks in the corresponding column of the first matrix. A frame during which an image is displayed on the liquid crystal display is divided into time slots, and a number of the time slots is equal to a number of the corresponding display blocks included in each column of the first matrix. A luminance of the light provided by each of the light-emitting blocks during each time slot of the frame is controlled based on an image data signal supplied to the corresponding column of the first matrix.

According to an alternative exemplary embodiment of the present invention, a method of driving an LCD which includes display blocks arranged in a first matrix and light-emitting blocks which correspond to a corresponding column of the first matrix and which provide light to corresponding display blocks included in the corresponding column. The method includes: providing light from the light-emitting blocks to the display blocks, the light having a luminance which changes sequentially according to an image data signal supplied to each of the display blocks; and receiving the light having the luminance which changes sequentially to display an image on a liquid crystal panel of the LCD.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is a block diagram of a liquid crystal display (“LCD”) according to an exemplary embodiment of the present invention;

FIG. 2 is an equivalent circuit diagram of a pixel included in the LCD according to the exemplary embodiment of the present invention shown in FIG. 1;

FIG. 3 is a schematic circuit diagram of first through (n×m)^{th} display blocks and first through m^{th} light-emitting blocks of an LCD according to the exemplary embodiment of the present invention shown in FIG. 1;

FIG. 4 is a schematic circuit diagram of first through (n×m)^{th} display blocks and first through m^{th} light-emitting blocks of an LCD according to an alternative exemplary embodiment of the present invention;

FIG. 5 is a block diagram of an image signal controller of the LCD according to the exemplary embodiment of the present invention shown in FIG. 1;

FIG. 6 is a block diagram of an optical data signal controller of an LCD according to the exemplary embodiment of the present invention shown in FIG. 1;

FIG. 7 is a diagram of rows and columns for explaining an operation of first through m^{th} light-emitting blocks of an LCD according to the exemplary embodiment of the present invention shown in FIG. 1;

FIG. 8 is a signal timing diagram of signals provided to first through sixty-fourth display blocks of an LCD according to the exemplary embodiment of the present invention shown in FIG. 7;

FIG. 9 is a signal timing diagram of signals provided to first through eighth light-emitting blocks of an LCD according to the exemplary embodiment of the present invention shown in FIG. 7;

FIG. 10 is a schematic circuit diagram of a backlight driver of an LCD according to the exemplary embodiment of the present invention shown in FIG. 1;

FIG. 11 is an equivalent circuit diagram of a pixel included in an LCD according to an alternative exemplary embodiment of the present invention;

FIG. 12 is a signal timing diagram showing signals provided to first through sixty-fourth display blocks of the LCD according to the exemplary embodiment of the present invention shown in FIG. 7 to explain the LCD and the method of driving the same according to an alternative exemplary embodiment of the present invention;

FIG. 13 is a block diagram of an LCD and a method of driving the same according to yet another alternative exemplary embodiment of the present invention;

FIG. 14 is a block diagram of an image signal controller of an LCD according to the exemplary embodiment of the present invention shown in FIG. 13;

FIG. 15 is a block diagram of an optical data signal controller of an LCD according to the exemplary embodiment of the present invention shown in FIG. 13;

FIG. 16 is a diagram showing pixels included in one display block of an LCD according to the exemplary embodiment of the present invention shown in FIG. 13; and

FIG. 17 is a signal timing diagram of signals provided to the display block of the LCD according to the exemplary embodiment of the present invention shown in FIG. 16 and an optical data signal provided to a light-emitting block which provides light to the display block.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

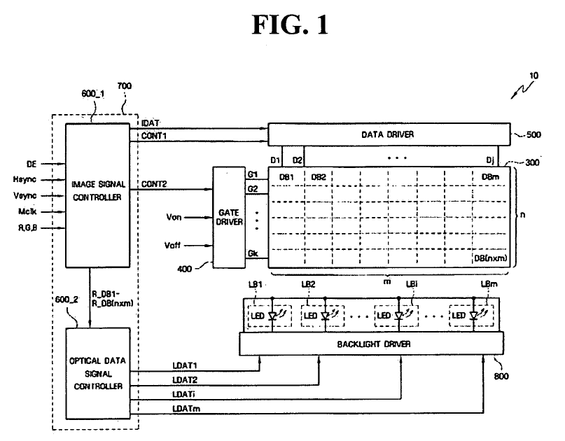

Hereinafter, a liquid crystal display (“LCD”) and a method of driving the same according to exemplary embodiments of the present invention will be described in further detail with reference to FIGS. 1 through 10.

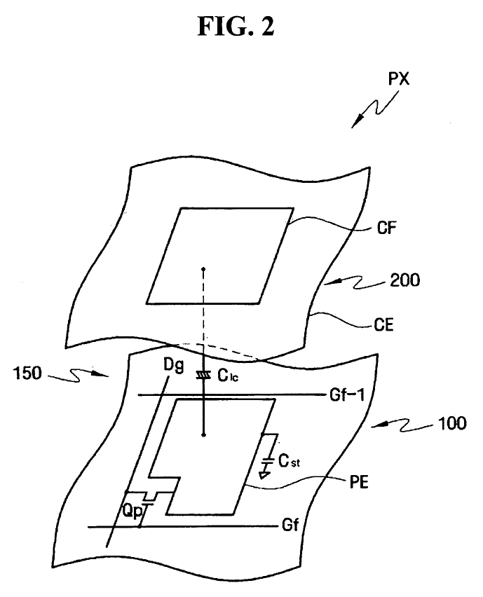

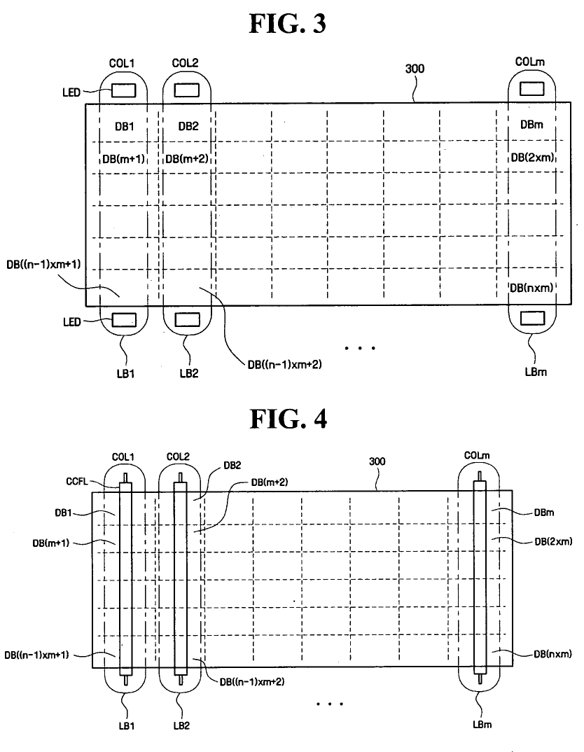

FIG. 1 is a block diagram of an LCD 10 and a method of driving the same according to an exemplary embodiment of the present invention. FIG. 2 is an equivalent circuit diagram of a pixel PX included in the LCD 10 in the LCD according to the exemplary embodiment of the present invention shown in FIG. 1. FIG. 3 is a schematic circuit diagram illustrating an arrangement of first through (n×m)^{th} display blocks DB1 through DB(n×m) and first through m^{th} light-emitting blocks LB1 through LBm of the LCD 10 according to the exemplary embodiment of the present invention shown in FIG. 1. FIG. 4 is a schematic circuit diagram illustrating an alternative arrangement of the first through (n×m)^{th} display blocks DB1 through DB(n×m) and the first through m^{th} light-emitting blocks LB1 through LBm of the LCD 10 according to an alternative exemplary embodiment of the present invention shown in FIG. 1.

Referring to FIG. 1, the LCD 10 includes a liquid crystal panel 300, a gate driver 400, a data driver 500, a signal controller 700, a backlight driver 800 and the first through m^{th} (where m is a natural number) light-emitting blocks LB1 through LBm connected to the backlight driver 800.

In an alternative exemplary embodiment, the signal controller 700 includes an image signal controller 600_1 and an optical data signal controller 600_2. The image signal controller 600_1 controls an image displayed on the liquid crystal panel 300, and the optical data signal controller 600_2 controls the backlight driver 800. In an exemplary embodiment, the image signal controller 600_1 and the optical data signal controller 600_2 may be physically separated from each other in the LCD 10.

The liquid crystal panel 300 includes the first through (n×m)^{th} display blocks DB1 through DB(n×m) which together display the image. The first through (n×m)^{th} display blocks DB1 through DB(n×m) are arranged in a first matrix of n rows and m columns (where n and am are natural numbers). In this case display blocks in each column of the first matrix correspond to one of the first through m^{th} light-emitting blocks LB1 through LBm. For example, display blocks in an i^{th} column of the first matrix may correspond to an i^{th} light-emitting block LBi.

The liquid crystal panel 300 includes a plurality of gate lines G1 through Gk and a plurality of data lines D1 through Dj (where j and k are natural numbers). In an exemplary embodiment of the present invention, each pixel PX is disposed in a region defined by an area where a gate line Gk of the plurality of gate lines G1 through Gk and a data line Dj of the plurality of data lines D1 through Dj cross each other. Each of the first through (n×m)^{th} display blocks DB1 through DB(n×m) includes a plurality of pixels PX.

FIG. 2 is an equivalent circuit diagram of one pixel PX. Referring to FIG. 2, a pixel PX is connected to, for example, an f^{h}(f=1 to k) gate line Gf and a g^{th} (g=1 to j) data line Dg and includes a switching device Qp, which is connected to the f^{th} gate line Gf and the g^{th} data line Dg, and a liquid crystal capacitor Clc and a storage capacitor Cst which are connected to the switching device Qp. In an exemplary embodiment of the present invention, the switching device Qp is a thin film transistor (“TFT”), but alternative exemplary embodiments are not limited thereto.

As shown in FIG. 2, the liquid crystal capacitor Clc includes two electrodes, such as a pixel electrode PE of a first display substrate 100 and a common electrode CE of a second display substrate 200, for example, and liquid crystal molecules 150 interposed between the pixel electrode PE and the common electrode CE. A color filter CF is formed on a portion of the common electrode CE.

The pixel PX includes two electrodes which generate an electric field therebetween. To display the image, the liquid crystal molecules 150 are aligned by the electric field generated between the two electrodes. As shown in FIG. 2, the liquid crystal molecules 150 are aligned by an electric field generated between the pixel electrode PE of the first display substrate 100 and the common electrode CE of the second display substrate 200. When the liquid crystal molecules 150 are aligned, their arrangement is changed and the pixel PX thereby displays a desired image. The liquid crystal capacitor Clc and the storage capacitor Cst help maintain the electric field generated between the two electrodes, thereby extending a period of time during which the liquid crystal molecules 150 are aligned.

Referring back to FIG. 1, the signal controller 700 receives red, green and blue image signals R, G and B, respectively, and other external control signals for controlling display of the red, green and blue image signals R, G and B, respectively, and outputs an image data signal IDAT, a data control signal CONT1, a gate control signal CONT2, and first through m^{th} optical data signals LDAT1 through LDATm. More specifically, the signal controller 700 receives the red, green and blue image signals R, G and B, respectively, and outputs the image data signal IDAT based on the red, green and blue image signals R, G and B, respectively. In addition, the signal controller 700 outputs the first through m^{th} optical data signals LDAT1 through LDATm corresponding to portions of the image which are displayed on the first through (n×m)^{th} display blocks DB1 through DB(n×m) based on the red, green and blue image signals R, G and B, respectively.

Specifically, the image signal controller 600_1 receives the red, green and blue image signals R, G and B, respectively, and outputs the image data signal IDAT which corresponds to the red, green and blue image signals R, G and B, respectively. In addition, the image signal controller 600_1 receives the external control signals from an external source (not shown) and generates the data control signal CONT1 and the gate control signal CONT2. In an exemplary embodiment of the present invention, the external control signals include a vertical synchronization signal Vsync, a horizontal synchronization signal Hsync, a main clock signal Mclk, and a data enable signal DE, for example, but alternative exemplary embodiments are not limited thereto. The data control signal CONT1 controls an operation of the data driver 500, and the gate control signal CONT2 controls an operation of the gate driver 400.

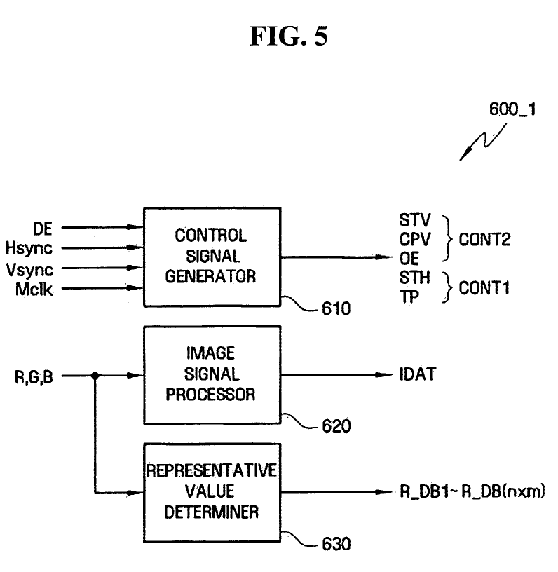

The image signal controller 600_1 receives the red, green and blue image signals R, G and B, respectively, and outputs a plurality of representative image signals R_DB1 through R_DB(n×m), which correspond to the first through (n×m)^{th} display blocks DB1 through DB(n×m), respectively, to the optical data signal controller 600_2. An operation and internal structure of the image signal controller 600_1 will be described in greater detail below with reference to FIG. 5.

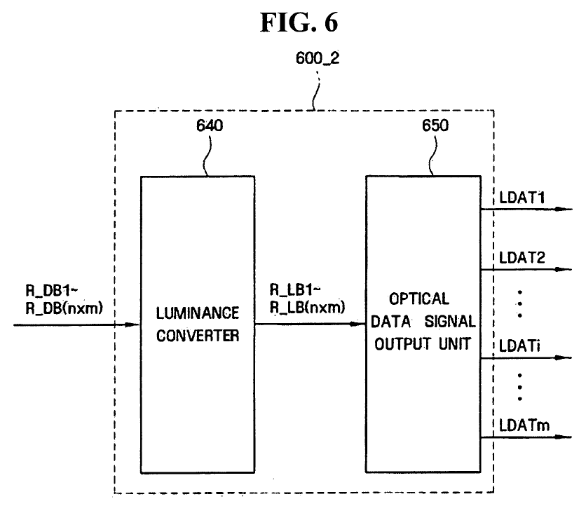

The optical data signal controller 600_2 receives the representative image signals R_DB1 through R_DB(n×m), generates the first through m^{th} optical data signals LDAT1 through LDATm based on the representative image signals R_DB1 through R_DB(n×m), and provides the first through m^{th} optical data signals LDAT1 through LDATm to the backlight driver 800. An operation and internal structure of the optical data signal controller 600_2 will be described in further detail below with reference to FIG. 6.

The gate driver 400 receives the gate control signal CONT2 from the image signal controller 600_1 and transmits a gate signal to the gate lines G1 through Gk. The gate signal includes a gate-on voltage Von and a gate-off voltage Voff provided by a gate on/off voltage generator (not shown). The gate control signal CONT2 controls the operation of the gate driver 400 and includes, for example, a vertical start signal STV (FIG. 5) for starting an operation of the gate driver 400, a gate clock signal CPV (FIG. 5) for determining when to output the gate-on voltage Von, and an output enable signal OE (FIG. 5) for determining a pulse width of the gate-on voltage Von.

The data driver 500 receives the data control signal CONT1 from the image signal controller 600_1 and applies a voltage which corresponds to the image data signal IDAT to the data lines D1 through Dj. The data control signal CONT1 includes signals used to control the operation of the data driver 500. More specifically, the signals used to control the operation of the data driver 500 in an exemplary embodiment include a horizontal start signal STH (FIG. 5) for starting an operation the data driver 500 and an output instruction signal TP (FIG. 5) for instructing output of an image data voltage.

As shown in FIG. 1, the first through m^{th} light-emitting blocks LB1 through LBm are disposed under the liquid crystal panel 300 and provide light to the liquid crystal panel 300. In an exemplary embodiment of the present invention, the first through m^{th} light-emitting blocks LB1 through LBm are arranged as shown in FIGS. 3 and 4. Specifically, the first through m^{th} light-emitting blocks LB1 through LBm may correspond to first through m^{th} columns COL1 through COLm of the first through (n×m)^{th} display blocks DB1 through DB(n×m) which are arranged in the first matrix. Put another way, the first through (n×m)^{th} display blocks DB1 through DB(n×m) may be arranged in a matrix of n rows and m columns, and the first through m^{th} light-emitting blocks LB1 through LBm may correspond to the first through m^{th} columns COL1 through COLm of the matrix, respectively. Each of the first through m^{th} light-emitting blocks LB1 through LBm provide light to a corresponding one of the first through m^{th} columns COL1 through COLm of the first through (n×m)^{th} display blocks DB1 through DB(n×m) which are arranged in the first matrix.

Light sources included in the first through m^{th} light-emitting blocks LB1 through LBm may be arranged as edge-type light sources, as shown in FIG. 3, but alternative exemplary embodiments are not limited thereto. As shown in FIG. 3, the light sources are point light sources, such as light-emitting diodes (“LEDs”), which are arranged under both sides of the liquid crystal panel 300. Alternatively, the light sources included in the first through m^{th} light-emitting blocks LB1 through LBm may be arranged directly under the liquid crystal panel 300, as shown in FIG. 4. In this case, the light sources may be line light sources which are arranged substantially parallel to each other and are disposed under the first through m^{th} columns COL1 through COLm of the first through (n×m)^{th} display blocks DB1 through DB(n×m). The line light sources in an exemplary embodiment of the present invention may be, for example, cold cathode fluorescent lamps (“CCFLs”) or, alternatively, hot cathode fluorescent lamps (“HCFLs”), but alternative exemplary embodiments are not limited thereto.

Referring again to FIG. 1, the backlight driver 800 controls respective luminances of the first through m^{th} light-emitting blocks LB1 through LBm in response to the first through m^{th} optical data signal LDAT1 through LDATm. A luminance of each of the first through m^{th} light-emitting blocks LB1 through LBm is controlled according to images respectively displayed on a given column of display blocks which receive light from the corresponding light-emitting block, e.g., is controlled based on an image data signal supplied to a given column of display blocks.

The image signal controller 600_1 of FIG. 1 will now be described in further detail with reference to FIGS. 5 and 6. FIG. 5 is a block diagram of the image signal controller 600_1 of the LCD according to the exemplary embodiment of the present invention shown in FIG. 1. FIG. 6 is a block diagram of the optical data signal controller 600_2 of the LCD according to the exemplary embodiment of the present invention shown in FIG. 1.

Referring to FIG. 5, the image signal controller 600_1 includes a control signal generator 610, an image signal processor 620 and a representative value determiner 630.

The control signal generator 610 receives external control signals and outputs the data control signal CONT1 and the gate control signals CONT2. In an exemplary embodiment, the control signal generator 610 may output the vertical start signal STV for starting an operation the gate driver 400 (FIG. 1), the gate clock signal CPV for determining when to output the gate-on voltage Von, the output enable signal OE for determining the pulse width of the gate-on voltage Von, the horizontal start signal STH for starting an operation of the data driver 500 of FIG. 1 and the output instruction signal TP for instructing the output of an image data voltage for example.

The image signal processor 620 may receive the red, green and blue image signals R, G and B, respectively, and may convert the red, green and blue image signals R, G and B, respectively, into the image data signal IDAT, and thereafter may output the image data signal IDAT.

The representative value determiner 630 determines the representative image signals R_DB1 through R_DB(n×m) which correspond to the first through (n×m)^{th} display blocks DB1 through DB(n×m), respectively. More specifically, for example, the representative value determiner 630 according to an exemplary embodiment of the present invention receives the red, green and blue image signals R, G and B, respectively, and determines the representative image signals R_DB1 through R_DB(n×m). In an exemplary embodiment, each of the representative image signals R_DB1 through R_DB(n×m) may be a mean of the red, green and blue image signals R, G and B, respectively, which are provided to each of the first through (n×m)h display blocks DB1 through DB(n×m). Thus, each of the representative image signals R_DB1 through R_DB(n×m) denote a mean luminance of each of the first through (n×m)^{th} display blocks DB1 through DB(n×m). In an alternative exemplary embodiment of the present invention, each of the representative image signals R_DB1 through R_DB(n×m) denotes a grayscale level of each of the first through (n×m)^{th} display blocks DB1 through DB(n×m).

The representative value determiner 630 may also determine the representative image signals R_DB1 through R_DB(n×m), which correspond to the first through (n×m)^{th} display blocks DB1 through DB(n×m), respectively, based on the image data signal IDAT.

Referring now to FIG. 6, the optical data signal controller 600_2 according to an exemplary embodiment includes a luminance converter 640 and an optical data signal output unit 650.

The luminance converter 640 receives the representative image signals R_DB1 through R_DB(n×m), determines luminances R_LB1 through R_LB(n×m) of the first through m^{th} light-emitting blocks LB1 through LBm (FIG. 1) which correspond to the representative image signals R_DB1 through R_DB(n×m), respectively, and outputs determined luminances R_LB1 through R_LB(n×m) of the first through m^{th} light-emitting blocks LB1 through LBm to the signal output unit 650. The luminance converter 640 may also determine the luminances R_LB1 through R_LB(n×m) of the first through m^{th} light-emitting blocks LB1 through LBm which correspond to the representative image signals R_DB1 through R_DB(n×m), respectively, using a lookup table (not shown), but alternative exemplary embodiments of the present invention are not limited thereto.

The optical data signal output unit 650 outputs the first through m^{th} optical data signals LDAT1 through LDATm which are thereafter transmitted to the first through m^{th} light-emitting blocks LB1 through LBm (FIG. 1), respectively. Each of the first through m^{th} optical data signals LDAT1 through LDATm may be determined based on images, e.g., the image data signal, respectively displayed on a column of display blocks which receive light from a corresponding one of the first through m^{th} light-emitting blocks LB1 through LBm. The first through m^{th} optical data signals LDAT1 through LDATm will be described below in greater detail with reference to an operation of the first through m^{th} light-emitting blocks LB1 through LBm.

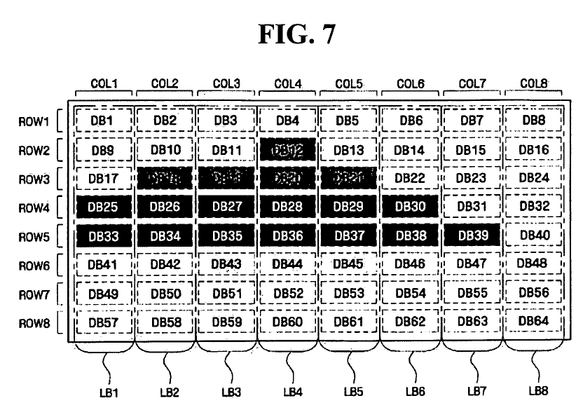

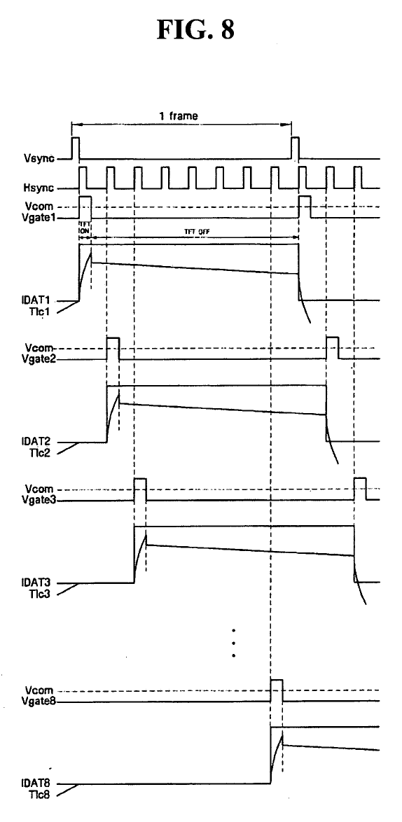

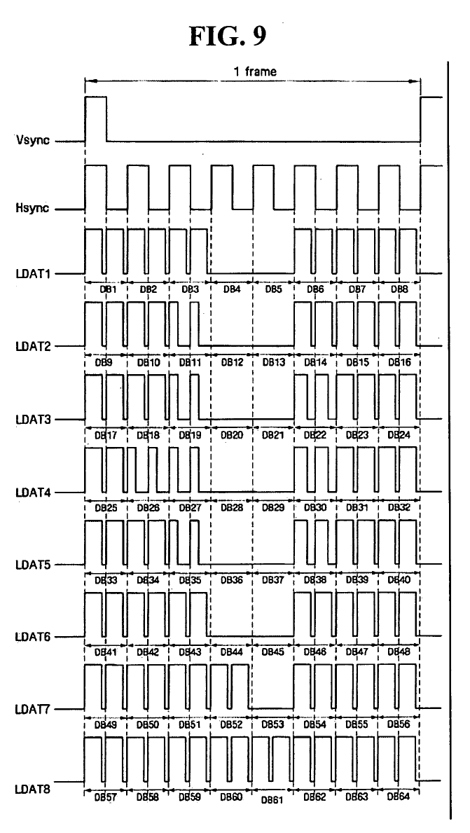

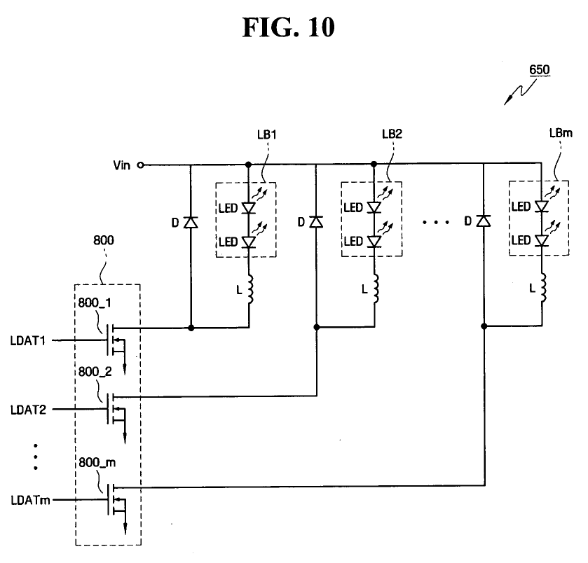

The operation of the first through m^{th} light-emitting blocks LB1 through LBm of FIG. 1 will now be described in further detail with reference to FIGS. 7 through 10. FIG. 7 is a diagram of rows and columns of the first matrix for explaining an operation of the first through m^{th} light-emitting blocks LB1 through LBm of the LCD 10 according to the exemplary embodiment of the present invention shown in FIG. 1. FIG. 8 is a signal timing diagram of signals provided to first through sixty-fourth display blocks DB1 through DB64 of the LCD 10 according to the exemplary embodiment of the present invention shown in FIG. 7. FIG. 9 is a signal timing diagram of signals provided to the first through eighth light-emitting blocks LB1 through LB8 of the LCD 10 according to the exemplary embodiment of the present invention shown in FIG. 7. FIG. 10 is a schematic circuit diagram of the backlight driver 800 of the LCD 10 according to the exemplary embodiment of the present invention shown in FIG. 1.

For purposes of simplicity in explanation, the exemplary embodiment of the present invention shown in FIG. 7 illustrates a case where the first through (n×m)^{th} display blocks DB1 through DB(n×m) are arranged in eight rows and eight columns, e.g., a case where m and n are both equal to eight. However, alternative exemplary embodiments of the present invention are not limited thereto.

As shown in FIG. 7, the first through eighth light-emitting blocks LB1 through LB8 and the first through sixty-fourth display blocks DB1 through DB64 are grouped together in a matrix pattern, e.g., to form the first matrix. Referring to FIG. 7, each of the first through eighth light-emitting blocks LB1 through LB8 provides light to display blocks in a corresponding one of the first through eighth columns COL1 through COL8. In FIG. 7, a darkness of each of the first through sixty-fourth display blocks DB1 through DB64 indicates a relative luminance thereof Specifically a white color indicates a highest luminance, while a black color indicates a lowest luminance. Similarly, an intermediate darkness, e.g., between white and black colors, indicates an intermediate luminance. Thus, a luminance of the twenty-seventh display block DB27 in FIG. 7 represents the lowest luminance, while a luminance of the first display black DB1 is the highest luminance, and a luminance of the twelfth display block DB12 is between the luminances of the twenty-seventh display block DB27 and the first display black DB1.

Signals provided to the first through sixty-fourth display blocks DB1 through DB64 of FIG. 7 and alignment the liquid crystal molecules 150 (FIG. 2) based thereon will now be described in further detail with reference to FIG. 8. Signals shown in FIG. 8 are transmitted to the first, ninth, seventeenth, twenty-fifth, thirty-third, forty-first, forty-ninth and fifty-seventh display blocks DB1, DB9, DB17, DB25, DB33, DB41, DB49 and DB57 in the first column COL1 of FIG. 7. In FIG. 8, the term “TFT ON/OFF” indicates whether a corresponding switching device Qp (shown in FIG. 2) is on or off.

Although the following description is based on operation of the first column COL1, it also applies to all other columns. In addition, although each of the first through sixty-fourth display blocks DB1 through DB64 includes a plurality of pixels PX (FIG. 2), it will be assumed for simplicity of description herein that each of the first through sixty-fourth display blocks DB1 through DB64 includes one pixel PX which represents an average of all pixels PX therein.

Referring now to FIG. 8, a frame, e.g., a time period during which an image is displayed on the liquid crystal panel 300 (FIG. 1), is initiated by a pulse of the vertical synchronization signal Vsync. More specifically, the vertical synchronization signal Vsync indicates a start of a given frame. Thus, the term “a frame” refers to a period of time between adjacent pulses of the vertical synchronization signal Vsync. During a single frame, the first through sixty-fourth display blocks DB1 through DB64 are turned on sequentially on a row-by-row basis.

The horizontal synchronization signal Hsync is used to distinguish rows of gate lines from each other. Thus, the horizontal synchronization signal Hsync according to an exemplary embodiment has a number of pulses equal to a number of rows. Thus, as shown in FIG. 8, the horizontal synchronization signal Hsync has eight pulses. Accordingly, display blocks in each of the first through eighth rows ROW1 through ROW8 are sequentially turned on in a row-by-row basis in synchronization with each pulse of the horizontal synchronization signal Hsync.

A plurality of gate signals Vgate1 through Vgate8 are transmitted to respective pixels PX (FIG. 2) of the first, ninth, seventeenth, twenty-fifth, thirty-third, forty-first, forty-ninth and fifty-seventh display blocks DB1, DB9, DB17, DB25, DB33, DB41, DB49 and DB57, respectively, in the first column COL1, in synchronization with the pulses of the horizontal synchronization signal Hsync. When voltage levels of the gate signals Vgate1 through Vgate8 are higher than a level of a common voltage Vcom, respective pixels PX of the first, ninth, seventeenth, twenty-fifth, thirty-third, forty-first, forty-ninth and fifty-seventh display blocks DB1, DB9, DB17, DB25, DB33, DB41, DB49 and DB57, respectively, are sequentially turned on.

When the pixels PX of the first, ninth, seventeenth, twenty-fifth, thirty-third, forty-first, forty-ninth and fifty-seventh display blocks DB1, DB9, DB17, DB25, DB33, DB41, DB49 and DB57 are sequentially turned on, a plurality of image data signals IDAT1 through IDAT8 are transmitted to the abovementioned pixels PX. Accordingly, orientations of liquid crystal molecules 150 (FIG. 2) included in each of the turned on pixels PX are adjusted. When the orientations of the liquid crystal molecules 150 are adjusted, e.g., their arrangement is changed by an electric field formed therein, an amount of light passing therethrough is adjusted to display the desired image. Further, reference characters Tlc1 through Tlc8 in FIG. 8 indicate a relative light transmittance of liquid crystal molecules 150 included in each of the respective pixels PX of the first, ninth, seventeenth, twenty-fifth, thirty-third, forty-first, forty-ninth and fifty-seventh display blocks DB1, DB9, DB17, DB25, DB33, DB41, DB49 and DB57, respectively.

As shown in FIG. 8, the light transmittances Tlc1 through Tlc8 of the liquid crystal molecules 150 gradually decrease after the voltage levels of the gate signals Vgate1 through Vgate8 become lower than that of the common voltage Vcom.

An operation in which first through eighth optical data signals LDAT1 through LDAT8 are provided to the first through eighth light-emitting blocks LB1 through LB8 of FIG. 7, respectively, will now be described in further detail with reference to FIG. 9.

In an exemplary embodiment of the present invention, a frame, during which an image is displayed on the liquid crystal panel 300 (FIG. 1), is divided into time slots. Further, a number of the time slots of the frame is equal to a number of display blocks included in each column of the first matrix (FIG. 7). For example, a frame may be divided into eight time slots, as in the exemplary embodiment shown in FIG. 9. Further, each time slot of the frame refers to a period of time from a beginning of an associated pulse of the horizontal synchronization signal Hsync to the start of a next pulse thereof.

The first through eighth optical data signals LDAT1 through LDAT8 are transmitted to the first through eighth light-emitting blocks LB1 through LB8 of FIG. 7, respectively. Thus, each of the first through eighth optical data signals LDAT1 through LDAT8 controls a luminance of light provided by each of the first through eighth light-emitting blocks LB1 through LB8. Further, each of the first through eighth optical data signals LDAT1 through LDAT8 may be divided into a number of time slots equal to the time slots into which the frame is divided, e.g., eight, as shown in FIG. 9. In addition, each time slot of each of the first through eighth optical data signals LDAT1 through LDAT8 may be determined by an image displayed on one of a column of associated display blocks which receive light from a corresponding one of the first through eighth light-emitting blocks LB1 through LB8. Put another way, the time slots of each of the first through eighth optical data signals LDAT1 through LDAT8 may be determined by images respectively displayed on display blocks which are shown thereunder, as best illustrated in FIG. 9.

Thus, in an exemplary embodiment, for example, the first optical data signal LDAT1 is divided into a number of time slots equal to the number of time slots into which a frame is divided, e.g., eight time slots. In this case, each time slot of the first optical data signal LDAT1 maybe determined by an image displayed on one of the first, ninth, seventeenth, twenty-fifth, thirty-third, forty-first, forty-ninth and fifty-seventh display blocks DB1, DB9, DB17, DB25, DB33, DB41, DB49 and DB57, respectively, in the first column COL1.

Further, a duty ratio, which corresponds to a pulse width of the first optical data signal LDAT1, of each time slot of the first optical data signal LDAT1 is determined by one of the first, ninth, seventeenth, twenty-fifth, thirty-third, forty-first, forty-ninth and fifty-seventh representative image signals R_DB1, R_DB9, R_DB17, R_DB25, R_DB33, R_DB41, R_DB49 and R_DB57, respectively, of the first, ninth, seventeenth, twenty-fifth, thirty-third, forty-first, forty-ninth and fifty-seventh display blocks DB1, DB9, DB17, DB25, DB33, DB41, DB49 and DB57, respectively, in the first column COL1. As the duty ratio is increased, e.g., as the pulse width of the first optical data signal LDAT1 is increased, a luminance of light provided by the first light-emitting block LB1 increases.

Referring again to FIG. 7, luminances of the first, ninth, seventeenth, forty-first, forty-ninth, and fifty-seventh display blocks DB1, DB9, DB17, DB41, DB49 and DB57, respectively, are highest, while luminances of the twenty-fifth and thirty-third display blocks DB25 and DB33, respectively, are lowest. Thus, a duty ratio of the first optical data signal LDAT1 varies according to the luminance of each of the first, ninth, seventeenth, twenty-fifth, thirty-third, forty-first, forty-ninth and fifty-seventh display blocks DB1, DB9, DB17, DB25, DB33, DB41, DB49 and DB57, respectively. Specifically, the first optical data signal LDAT1 includes a series of sequential pulse width modulation (“PWM”) signals, for example, each having duty ratios which correspond to the first, ninth, seventeenth, twenty-fifth, thirty-third, forty-first, forty-ninth and fifty-seventh display blocks DB1, DB9, DB17, DB25, DB33, DB41, DB49 and DB57, respectively, in the first column COL1.

Therefore, the luminance of light provided by the first light-emitting block LB1, which receives the first optical data signal LDAT1, during each time slot of a given frame is determined by an image displayed on each of the first, ninth, seventeenth, twenty-fifth, thirty-third, forty-first, forty-ninth, and fifty-seventh display blocks DB1, DB9, DB17, DB25, DB33, DB41, DB49 and DB57, respectively, which receive light from the first light-emitting block LB1. Thus, the luminance of light provided by the first light-emitting block LB1 during the given frame changes sequentially according to an image displayed on each of the first, ninth, seventeenth, twenty-fifth, thirty-third, forty-first, forty-ninth and fifty-seventh display blocks DB1, DB9, DB17, DB25, DB33, DB41, DB49 and DB57, respectively.

Referring again to FIG. 8, each of the light transmittances Tlc1 through Tlc8 of the liquid crystal molecules is highest during a period of time between a corresponding pulse of the horizontal synchronization signal Hsync and a next pulse, e.g., a subsequent adjacent pulse, thereof, e.g., in a period of time corresponding to each time slot into which the given frame is divided. Thus, the first optical data signal LDAT1 is provided while the light transmittance of the liquid crystal molecules 150 included in each pixel PX is highest, as shown in FIGS. 8 and 9.

In an exemplary embodiment, the duty ratio of the first optical data signal LDAT1 is controlled based on an image displayed on each of the first, ninth, seventeenth, twenty-fifth, thirty-third, forty-first, forty-ninth and fifty-seventh display blocks DB1, DB9, DB17, DB25, DB33, DB41, DB49 and DB57, respectively. Thus, the first optical data signal LDAT1, which reflects the luminance of each of the first, ninth, seventeenth, twenty-fifth, thirty-third, forty-first, forty-ninth and fifty-seventh display blocks DB1, DB9, DB17, DB25, DB33, DB41, DB49 and DB57, respectively, is provided in synchronization with the turn-on time of the liquid crystal molecules included in each of the first, ninth, seventeenth, twenty-fifth, thirty-third, forty-first, forty-ninth and fifty-seventh display blocks DB1, DB9, DB17, DB25, DB33, DB41, DB49 and DB57, respectively.

As a result, by efficiently utilizing the turn-on time of the liquid crystal molecules, as described above, a contrast ratio between the first, ninth, seventeenth, twenty-fifth, thirty-third, forty-first, forty-ninth and fifty-seventh display blocks DB1, DB9, DB17, DB25, DB33, DB41, DB49 and DB57, respectively, which receive light from the first light-emitting block LB1 may be increased, thereby substantially enhancing a display quality of the LCD 10 according to an exemplary embodiment of the present invention.

It will be noted that the detailed description above regarding the first optical data signal LDAT1 also applies to the second through eighth optical data signals LDAT2 through LDAT8.

Thus, in an LCD 10 according to an exemplary embodiment of the present invention a frame is divided into a predetermined number of time slots, and a duty ratio for each of the first, ninth, seventeenth, twenty-fifth, thirty-third, forty-first, forty-ninth and fifty-seventh display blocks DB1, DB9, DB17, DB25, DB33, DB41, DB49 and DB57, respectively, is determined. Therefore, each of the first through eighth optical data signals LDAT1 through LDAT8 provided to the first through eighth light-emitting blocks LB1 through LB8, respectively, has a different duty ratio in each time slot of the frame. Further, each of the first through eighth optical data signals LDAT1 through LDAT8 is divided into time slots, and each of the time slots has a duty ratio for one column of display blocks which receive light from among each of the first through eighth light-emitting blocks LB1 through LB8. Therefore, each of the first through eighth optical data signals LDAT1 through LDAT8 represent image information regarding a corresponding column of display blocks, thereby further enhancing the display quality of the LCD 10 according to an exemplary embodiment.

As stated above, although each of the first through sixty-fourth display blocks DB1 through DB64 according to an exemplary embodiment includes a plurality of pixels PX (FIG. 2), for purposes of simplicity, the above description has been made based on the assumption that each of the first through sixty-fourth display blocks DB1 through DB64 includes one pixel PX which represents the average multiple pixels PX for each of the first through sixty-fourth display blocks DB1 through DB64. However, in an exemplary embodiment, each of the first through sixty-fourth display blocks DB1 through DB64 includes a plurality of the pixels PX. More specifically, each of the first through sixty-fourth display blocks DB1 through DB64 according to an exemplary embodiment may include a plurality of pixels PX arranged in a second matrix, and the pixels PX thereof are turned on sequentially on a row-by-row basis, as described in greater detail above. In addition, each of the first through eighth optical data signals LDAT1 through LDAT8, transmitted to the first through eighth light-emitting blocks LB1 through LB8, respectively, may be divided into time slots corresponding to time slots into which a frame is divided.

In this case, each time slot of each of the first through eighth optical data signals LDAT1 through LDAT8 is initiated, e.g., begins, when a first row of pixels PX from among the pixels PX, which are included in each of the first through sixty-fourth display blocks DB1 through DB64 and arranged in the second matrix, are turned on.

In addition, each time slot of a frame may be further divided into a number of parts equal to a number of rows of the second matrix. Thus, each of the first through eighth optical data signals LDAT1 through LDAT8 are controlled by images respectively displayed on the pixels PX which are included in each of the first through sixty-fourth display blocks DB1 through DB64 and arranged in the second matrix. Put another way, each of the first through eighth optical data signals LDAT1 through LDAT8 are divided into time slots, and each of the time slots may be further divided into a number of parts equal to the number of rows of the second matrix. In this case, each of the parts has a duty ratio which varies based on an image displayed on each of the pixels PX which are included in each of the first through sixty-fourth display blocks DB1 through DB64 arranged in the second matrix.

An operation of the backlight driver 800 and the first through m^{th} light-emitting blocks LB1 through LBm of FIG. 1 will now be described in further detail with reference to FIG. 10.

Referring to FIG. 10, the backlight driver 800 according to an exemplary embodiment includes a plurality of switching devices 800_1 through 800_m. In operation, the backlight driver 800 controls luminances of the first through m^{th} light-emitting blocks LB1 through LBm based on the first through m^{th} optical data signals LDAT1 through LDATm, respectively, as described in greater detail above.

When the first through m^{th} optical data signals LDAT1 through LDATm are at a high level, the switching devices 800_1 through 800_m of the backlight driver 800 are turned on, and a power supply voltage Vin is applied to the first through m^{th} light-emitting blocks LB1 through LBm. Accordingly, an electric current flows through each of the first through m^{th} light-emitting blocks LB1 through LBm and an inductor L. In an exemplary embodiment of the present invention, the inductor L stores energy generated by the electric current. In contrast, hen the first through m^{th} optical data signals LDAT1 through LDATm are at a low level, the switching devices 800_1 through 800_{—}m of the backlight driver 800 are turned off, and each of the first through m^{th} light-emitting blocks LB1 through LBm, the inductor L, and a diode D form a closed circuit. Accordingly, electric current flows through the closed circuit. Specifically, the energy stored in the inductor L is discharged, thereby reducing an amount of the energy stored in the inductor L and subsequently reducing an amount of electric current.

As described in further detail above, since the duty ratios of the first through m^{th} optical data signals LDAT1 through LDATm determine periods of time during which the switching devices 800_1 through 800_{—}m are turned on, they also determine the luminances of the first through m^{th} light-emitting blocks LB1 through LBm, respectively.

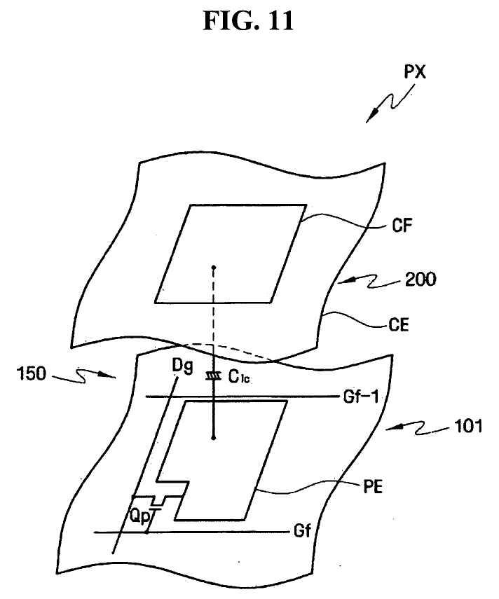

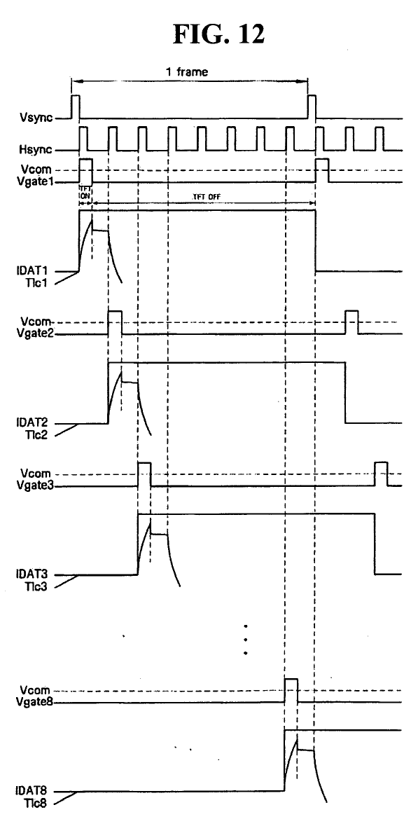

Hereinafter, an LCD 10 and a method of driving the LCD 10 according to an alternative exemplary embodiment of the present invention will be described in further detail with reference to FIGS. 11 and 12. Elements substantially the same as those of exemplary embodiments described above in greater detail are illustrated and described using the same reference numerals, and thus any repetitive detailed description thereof will hereinafter be omitted.

FIG. 11 is an equivalent circuit diagram of a pixel PX included in an LCD 10 (FIG. 1) according to an alternative exemplary embodiment of the present invention. Further, FIG. 11 is an equivalent circuit diagram for explaining the LCD 10 and a method of driving the same according to an alternative exemplary embodiment of the present invention. FIG. 12 is a signal timing diagram showing signals provided to the first through sixty-fourth display blocks DB1 through DB64 of the LCD 10 according to the alternative exemplary embodiment of the present invention shown in FIGS. 7 and 11 to further explain the LCD 10 and the method of driving the same according to the alternative exemplary embodiment of the present invention.

Referring to FIG. 11, the pixel PX included in the LCD 10 according to an exemplary embodiment does not include a storage capacitor Cst.

As a result and referring now to FIG. 12, a period of time during which the liquid crystal molecules 150 are aligned is reduced, since the storage capacitor Cst is not included in each pixel PX. Specifically, the storage capacitor Cst helps maintain an electric field generated between two electrodes, e.g., a pixel electrode PE of a first display substrate 101 and a common electrode CE of a second display substrate 200, thereby extending a period of time during which the liquid crystal molecules are turned on. Thus, removing the storage capacitor Cst reduces the period of time during which the liquid crystal molecules are aligned.

When the period of time during which the liquid crystal molecules 150 included in each pixel PX are aligned is reduced as described above, the period of time is utilized more efficiently in the LCD 10 according to an alternative exemplary embodiment of the present invention. Specifically, when the period of time during which the liquid crystal molecules 150 included in each pixel PX are aligned corresponds to each time slots into which a frame is divided, as shown in FIG. 12, the period of time is utilized at an effectively maximized efficiency.

In yet another alternative exemplary embodiment of the present invention, however, the storage capacitor Cst may be included in each pixel PX. In this case, a value of a liquid crystal capacitor Clc and that of the storage capacitor Cst is set such that a period of time during which liquid crystal molecules included in each pixel PX are turned on corresponds to each time slot of the frame, thereby effectively maximizing an operational efficiency of the LCD 10, even when the storage capacitor Cst is included therein.

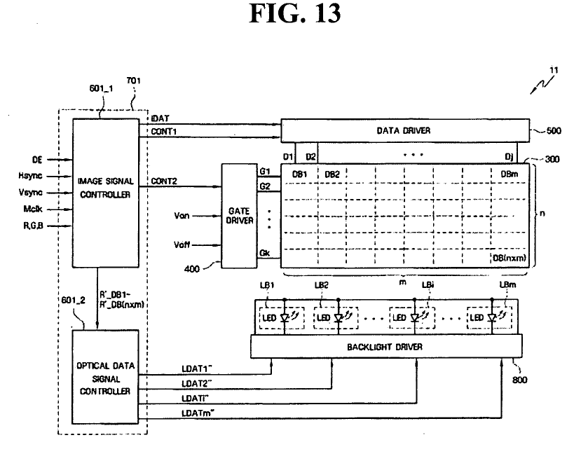

Hereinafter, an LCD 11 and a method of driving the LCD according to still other alternative exemplary embodiments of the present invention will be described in further detail with reference to FIGS. 13 through 17. Components shown in FIGS. 13 through 17 which are the same as components described in greater detail above are denoted with the same reference numerals, and any repetitive detailed description thereof has hereinafter been omitted.

FIG. 13 is a block diagram of the LCD 11 and a method of driving the same according to still another alternative exemplary embodiment of the present invention. Referring to FIG. 13, a signal controller 701 included in the LCD 11 according to an exemplary embodiment includes an image signal controller 601_1 and an optical data signal controller 601_2.

The signal controller 701 provides a plurality of optical data signals LDAT1″ through LDATm″ which reflect weights corresponding to images displayed on a plurality of display blocks DB1 through DB(n×m). In addition, the optical data signals LDAT1″ through LDATm″ are delayed signals in the LCD 11 according to an exemplary embodiment, as will be described in further detail below.

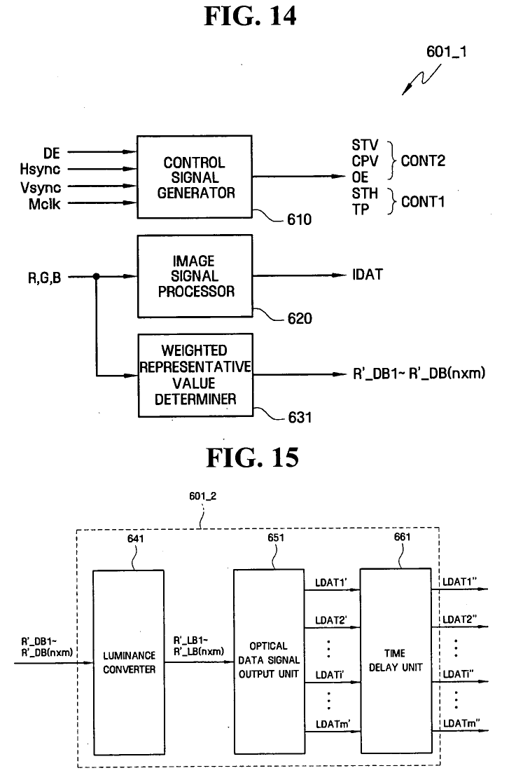

Specifically, the image signal controller 600_1 receives red, green and blue image signals R, G and B, respectively, outputs a plurality of weighted representative image signals R′_DB1-R′_DB(n×m) which correspond to the display blocks DB1 through DB(n×m), and provides the weighted representative image signals R′_DB1-R′_DB(n×m) to the optical data signal controller 601_2. An operation and internal structure of the image signal controller 601_1 will be described in further detail below with reference to FIG. 14.

The optical data signal controller 601_2 may receive the weighted representative image signals R′_DB1-R′_DB(n×m), generate the optical data signals LDAT1″ through LDATm″ which are weighted and delayed, and provide the weighted and delayed optical data signals LDAT1″ through LDATm″ to a backlight driver 800. The operation and internal structure of the optical data signal controller 601_2 will be described later with reference to FIG. 15.

FIG. 14 is a block diagram of the image signal controller 601_1 of the LCD according to the exemplary embodiment of the present invention shown in FIG. 13. Referring to FIG. 14, the image signal controller 601_1 includes a control signal generator 610, an image signal processor 620 and a weighted representative value determiner 631.

As described in greater detail above, the image signal controller 601_1 includes the weighted representative value determiner 631 which outputs the weighted representative image signals R′_DB1-R′_DB(n×m) based on the red, green and blue image signals R, G and B, respectively.

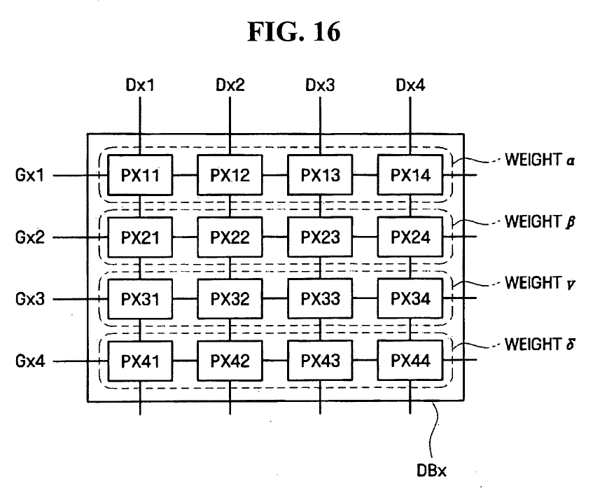

The weighted representative value determiner 631 determines the weighted representative image signals R′_DB1-R′_DB(n×m) which correspond to the display blocks DB1 through DB(n×m), respectively. The weighted representative value determiner 631 receives the red, green and blue image signals R, G and B, respectively, and determines the weighted representative image signals R′_DB1-R′_DB(n×m). In an exemplary embodiment of the present invention, for example, a mean of the red, green and blue image signals R, G and B, respectively, for pixels PX which are included in each of the display blocks DB1 through DB(n×m) and arranged in the second matrix, are calculated. Specifically, a different weight, based on a given row in which associated pixels PX are disposed, is given to the red, green and blue image signals R, G and B, respectively, and the weighted red, green and blue image signals R, G and B, respectively, are thereafter calculated to determine each of the weighted representative image signals R′_DB1-R′_DB(n×m), which will be described in further detail below with reference to FIG. 16.

FIG. 15 is a block diagram of the optical data signal controller 601_2 of the LCD according to the exemplary embodiment of the present invention shown in FIG. 13. Referring to FIG. 15, the optical data signal controller 601_2 includes a luminance converter 641, an optical data signal output unit 651 and a time delay unit 661.

The luminance converter 641 receives the weighted representative image signals R′_DB1 -R′_DB(n×m), determines weighted luminances R′_LB1 -R′_LB(n×m) of a plurality of light-emitting blocks LB1 through LBm based on the weighted representative image signals R′_DB1-R′_DB(n×m), and provides the weighted luminances R′_LB1-R′_LB(n×m) corresponding to each of the light-emitting blocks LB1 through LBm to the optical data signal output unit 651.

The optical data signal output unit 651 receives the weighted luminances R′_LB1-R′_LB(n×m) for each of the light-emitting blocks LB1 through LBm and provides weighted optical data signals LDAT1′ through LDATm′ to the time delay unit 661. Each of the weighted optical data signals LDAT1′ through LDATm′ is determined by images displayed on a given column of display blocks which receive light from a corresponding one of the light-emitting blocks LB1 through LBm.

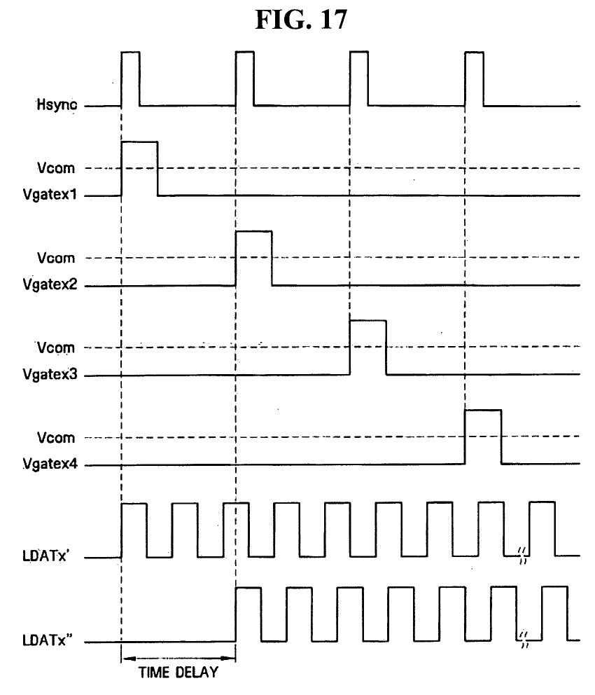

The time delay unit 661 receives the weighted optical data signals LDAT1′ through LDATm′ and delays the weighted optical data signals LDAT1′ through LDATm′ for a predetermined period of time. The time delay unit 661 will be described in further detail below with reference to FIG. 17.

Signals provided to the display blocks DB1 through DB(n×m) of FIG. 13 will now be described in further detail with reference to FIGS. 16 and 17. FIG. 16 is a diagram showing pixels PX included in a display block DBx selected from among the display blocks DB1 through DB(n×m) of the LCD 11 according to the exemplary embodiment of the present invention shown in FIG. 13. FIG. 17 is a signal timing diagram of signals provided to the display block DBx of the LCD 11 according to the exemplary embodiment of the present invention shown in FIG. 16, as well as an optical data signal provided to a light-emitting block which provides light to the display block DBx.

Referring to FIG. 16, the display block DBx includes four gate lines Gx1 through Gx4, four data lines Dx1 through Dx4, and sixteen pixels PX11 through PX44 which are formed in regions where the gate lines Gx1 through Gx4 cross the data lines Dx1 through Dx4, respectively. Put another way, the display block DBx includes the pixels PX11 through PX44 which are arranged in a matrix of four rows and four columns, as shown in FIG. 16.

In the display block DBx, the weighted representative image signals R′_DB1-R′DB(n×m) (described in greater detail above with reference to FIG. 14) are obtained as follows. A weight α is be allocated to the pixels PX11, PX12, PX13 and PX14 in a first row, a weight β is allocated to the pixels PX21, PX22, PX23 and PX24 in a second row, a weight γ is allocated to the pixels PX31, PX32, PX33 and PX34 in a third row, and a weight δ is allocated to the pixels PX41, PX42, PX43 and PX44 in a fourth row. A mean of image signals applied to the abovementioned pixels PX may therefore be calculated. Specifically, an image signal for each pixel PX is multiplied by a corresponding weight, and then a mean of the weighted image signals is determined. An optical data signal LDATx′, generated from the representative image signals R′_DB1-R′_DB(n×m) weighted as described above, is shown in FIG. 17.

Referring to FIG. 17, a horizontal synchronization signal Hsync includes a number of pulses equal to a number of rows of the second matrix included in the display block DBx, e.g., four pulses. In synchronization with each pulse of the horizontal synchronization signal Hsync, the pixels PX11 through PX64 are thereby turned on sequentially on row-by-row basis.

In an exemplary embodiment of the present invention, for example, gate signals Vgatex1 through Vgatex4 are transmitted to the pixels PX11, PX21, PX31 and PX41, respectively, in a first column, in synchronization with the pulses of the horizontal synchronization signal Hsync. When voltage levels of the gate signals Vgatex1 through Vgatex4 are greater than a level of the common voltage Vcom, the pixels PX11, PX21, PX31 and PX41 are turned on.

The optical data signal LDATx″, obtained by delaying the weighted optical data signal LDATx′, is then provided to the display block DBx. In an exemplary embodiment, when a highest weight is given to a second row, for example, from among the rows of the second matrix included in the display block DBx of FIG. 16, the optical data signal LDATx″ may be delayed until the pixels PX in the second row of the second matrix included in the display block DBx are turned on. Thus, when the optical data signal LDATx″ is delayed, as described above, the optical data signal LDATx″ more accurately represents images displayed on the highest weighted row of pixels PX, thereby enhancing a display quality of the LCD 11 according to an exemplary embodiment of the present invention.

According to exemplary embodiments of the present invention as described herein, an LCD and a method of driving the same provides advantages which include, but are not limited to, enhanced display quality.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and detail may be made therein without departing from the spirit or scope of the present invention as defined by the following claims.

What is claimed is:

1. A liquid crystal display comprising:
a liquid crystal panel including display blocks arranged in a first matrix thereon; and
light-emitting blocks which provide light to the liquid crystal panel,
wherein
each of the light-emitting blocks corresponds to a corresponding column of the first matrix and provides the light to a corresponding column of display blocks in the corresponding column of the first matrix,
a frame during which an image is displayed on the liquid crystal display is divided into time slots,
a number of the time slots of the frame is equal to a number of the corresponding column of display blocks, and
a luminance of the light provided by each of the light-emitting blocks during each time slot of the frame is controlled based on an image data signal supplied to the corresponding column of display blocks.

2. The liquid crystal display of claim 1, wherein
an optical data signal for controlling the luminance of the light which is provided by each of the light-emitting blocks to the corresponding column of display blocks is input to each of the light-emitting blocks,
the optical data signal is divided into time slots,
a number of the time slots of the optical data signal is equal to the number of the time slots of the frame, and
a value of the optical data signal for each time slot of the optical data signal is determined based on the image data signal supplied to the at least one display block of the corresponding column of display blocks.

3. The liquid crystal display of claim 1, wherein
an optical data signal for controlling the luminance of the light which is provided by each of the light-emitting blocks to the corresponding column of display blocks is input to each of the light-emitting blocks,
the optical data signal comprises a series of pulse width modulation signals, and
a duty ratio of each pulse width modulation signal of the series of pulse width modulation signals is based on the image data signal supplied to the at least one display block of the corresponding column of display blocks.

4. The liquid crystal display of claim 1, further comprising a signal controller which receives an image signal, determines representative image signals corresponding to each of the display blocks based on the image signal, and provides optical data signals generated from the representative image signals to each of the light-emitting blocks.

5. The liquid crystal display of claim 4, wherein
each of the optical data signals is divided into time slots corresponding to the time slots of the frame, and
each time slot of each of the optical data signals has a duty ratio determined by a representative image signal corresponding to the corresponding column of display blocks which receives the light.

6. The liquid crystal display of claim 4, wherein
each of the display blocks comprises pixels arranged in rows in a second matrix,
each of the optical data signals is divided into time slots corresponding to the time slots of the frame,
the pixels are turned on sequentially on a row-by-row basis, and
a beginning of each time slot of each of the optical data signals corresponds to a time when a first row of pixels in each of the display blocks is turned on.

7. The liquid crystal display of claim 1, wherein
each of the display blocks comprises pixels arranged in rows in a second matrix,
the pixels are turned on sequentially on a row-by-row basis,
each time slot of the frame is further divided into parts, and
a number of the parts is equal to a number of rows of the second matrix.

8. The liquid crystal display of claim 1, further comprising a signal controller which receives image signals, determines representative image signals corresponding to each of the display blocks based on the image signal, and provides optical data signals generated from the representative image signals to each of the light-emitting blocks, wherein
each of the display blocks comprises pixels,
the image signals correspond to pixels included in a given display block, and
each of the representative image signals is a mean of the image signals for the pixels included in the given display block.

9. The liquid crystal display of claim 1, wherein
each of the display blocks comprises pixels, and
each of the pixels comprises:
two electrodes which form an electric field therebetween;
liquid crystal molecules disposed between the two electrodes and which are aligned according to the electric field; and
a storage capacitor connected to one of the two electrodes and which extends a period of time during which the liquid crystal molecules are aligned, wherein a value of a liquid crystal capacitor formed by the two electrodes and a value of the storage capacitor are set such that the period of time during which the liquid crystal molecules are aligned is equal to a duration of each time slot of the frame.

10. The liquid crystal display of claim 1, wherein each of the display blocks comprises a plurality of pixels, and each pixel of the plurality of pixels comprises:
two electrodes which form an electric field therebetween; and
liquid crystal molecules which are aligned by the electric field.

11. The liquid crystal display of claim 1, further comprising a signal controller which receives an image signal, determines representative image signals corresponding to each of the display blocks based on the image signal, and provides optical data signals generated from the representative image signals to each of the light-emitting blocks, wherein
each of the display blocks comprises pixels arranged in rows in a second matrix,
each of the representative image signals is a mean of a weighted image signal for pixels included in a corresponding display block, and
the weighted image signal is obtained by assigning different weights to different rows of pixels in the second matrix.

12. The liquid crystal display of claim 11, wherein
the pixels are turned on sequentially on a row-by-row basis,
each of the optical data signals is divided into time slots corresponding to the time slots of the frame, and
a beginning time of each time slot of the optical data signals corresponds to a time when pixels in a row having a highest weight are turned on.

13. A method of driving a liquid crystal display which has display blocks arranged in a first matrix and light-emitting blocks which correspond to a corresponding column of the first matrix and which provide light to corresponding display blocks included in the corresponding column, the method comprising:
providing light from the light-emitting blocks to the display blocks, the light having a luminance which changes sequentially according to an image data signal supplied to each of the display blocks; and
receiving the light having the luminance which changes sequentially to display an image on a liquid crystal panel of the liquid crystal display.

14. The method of claim 13, wherein the providing the light having the luminance which changes sequentially comprises:
determining representative image signals which correspond to each column of display blocks based on image signals for each column of display blocks which receive light from a corresponding one of the light-emitting blocks; and
providing the light having the luminance which changes sequentially according to each of the representative image signals by using each of the light-emitting blocks for a frame during which the liquid crystal panel displays the image.

15. The method of claim 14, wherein
each of the display blocks comprises pixels, and
the determining the representative image signals comprises calculating a mean of image signals corresponding to pixels included in each of the display blocks.

16. The method of claim 14, wherein
each of the display blocks comprises pixels arranged in rows in a second matrix,
the determining the representative image signals comprises calculating a mean of weighted image signals corresponding to pixels included in each of the display blocks, and
the weighted image signals are obtained by assigning different weights to each row of pixels in the second matrix.

17. The method of claim 13, wherein
each of the light-emitting blocks receives an optical data signal the corresponding column of display blocks which are provided with light from the light-emitting block,
the optical data signal comprises a series of pulse width modulation signals, and
duty ratios of pulse width modulations signals of the plurality of pulse width modulation signals correspond to display blocks in each column.

18. The method of claim 17, wherein
each of the display blocks comprises pixels arranged in rows in a second matrix,
the pixels are turned on sequentially on a row-by-row basis, and
each of the pulse width modulation signals is initiated when a first row of pixels in each of the display blocks are turned on.

19. The method of claim 17, wherein
each of the display blocks comprises pixels arranged in rows in a second matrix,
the determining the representative image signals comprises calculating a mean of weighted image signals corresponding to pixels included in each of the display blocks,
the weighted image signals are obtained by giving a different weight according to each row of pixels in the second matrix,
the pixels are turned on sequentially on a row-by-row basis, and
each of the pulse width modulation signals is initiated when pixels in a row having a highest weight are turned on.

20. The method of claim 13, wherein each of the display blocks comprises pixels, each pixel comprising:
two electrodes which form an electric field therebetween; and
liquid crystal molecules which are aligned by the electric field, wherein
a frame during which the liquid crystal panel displays the image is divided time slots,
a number of the time slots is equal to a number of display blocks included in each column, and
a period of time during which the liquid crystal molecules are aligned corresponds to each time slot of the frame.
